(19) United States
(12) Patent Application Publication
(10) Pub. No.: US 2022/0059954 A1
(43) Pub. Date: Feb. 24, 2022

(54) HIGH SPEED CONNECTOR

(71) Applicant: AMPHENOL EAST ASIA ELECTRONIC TECHNOLOGY (SHENZHEN) CO., LTD., SHEN ZHEN (CN)

(72) Inventor: YU YUE, SHEN ZHEN (CN)

(21) Appl. No.: 16/998,845

(22) Filed: Aug. 20, 2020

(51) Int. Cl. H01R 12/63; H01R 13/502; H01R 24/60

(52) U.S. Cl. CPC H01R 12/63; H01R 24/60; H01R 13/502

(57) ABSTRACT

A high speed connector includes a metal casing, a plastic casing, and a terminal assembly; the metal casing including a main wall, a side wall, and a combination position; the plastic casing including a front connection portion, an engagement member, a protrusion, and a terminal engagement slot; the main wall including an engagement bore; the side wall disposed on the main wall; the combination portion formed between the main wall and the side wall; the front connection portion and the terminal engagement slot disposed in and on a lateral side of the cover body; the engagement member laterally disposed on the front connection portion; the protrusion disposed on the cover body; when the metal casing being engaged with the plastic casing, the protrusion being engaged in the engagement bore, and the protrusion being engaged in the combination position.

### BACKGROUND OF THE INVENTION

### 1. Field of the Invention

The present invention relates to high speed connectors, and more particularly, to a novel high speed connector.

### 2. Description of the Related Art

A high speed connector is a technique of wire junction for computer which is mainly for data transmission of peripheral components, such as an interface for equipment such as hard disks. However, it is desirable to improve the fastening stability of the connectors.

### SUMMARY OF THE INVENTION

For improving the issues above, a high speed connector is disclosed. Through the structural optimization, strength of the side wall is improved, whereby the stability thereof is increased.

For achieving the aforementioned objectives, a high speed connector is provided, comprising:

a metal casing, a plastic casing, and a terminal assembly;

the metal casing comprising a main wall, a side wall, and a combination position;

the plastic casing formed in a cuboid shape and comprising a front connection portion and a cover body, wherein the front connection portion and the cover body are connected to each other; the front connection portion comprising an engagement member; the cover body comprising a protrusion and a terminal engagement slot;

the main wall comprising an engagement bore disposed on the main wall;

the side wall disposed on two sides of the main wall;

the combination portion formed on a junction between the main wall and the side wall;

the front connection portion and the terminal engagement slot being disposed in the cover body and on a lateral side of the cover body, respectively;

the engagement member disposed on a lateral side of the front connection portion;

the protrusion disposed on an insertion end of a junction of the cover body;

when the metal casing being engaged with an outer side of the plastic casing, the engagement member being engaged in the engagement bore, and the protrusion being engaged in the combination position;

the terminal assembly being inserted in the front connection portion and comprising an upper terminal and a lower terminal; and

the upper terminal and the lower terminal comprising a metal pin and a plastic strip.

Preferably, the upper terminal related to the high speed connector comprises a bolt strip; the bolt strip being disposed on a later side of the upper terminal and comprising a bolt body; the bolt body disposed on the other end portion of the bolt strip connecting the upper terminal. When the upper terminal is inserted in the front connection portion, the bolt body is pressed by the terminal engagement slot to deform, so as to be placed into the terminal engagement slot, and subsequently restored to the original bolt body shape and fitted in the terminal engagement slot. Therefore, the bolt strip is fastened in the terminal engagement slot.

Preferably, the side wall related to the high speed connector comprises a foot; the foot being disposed on one side of the side wall which is connected with a PCB (printed circuit board); the foot being formed in a straight foot type or a patch type; the straight foot type foot presented in a straight plate shape, the patch type foot presented in a curve body.

Preferably, the terminal assembly related to the high speed connector comprises an engagement stud and an engagement slot; the engagement stud disposed on the lower terminal; the engagement slot disposed on the upper terminal; the upper terminal and the lower terminal being engaged through the engagement stud and the engagement slot.

With such configuration, the present invention achieves following advantages. Compared to prior arts, the high speed connector of the present invention is structurally optimized, wherein the strength of the side wall of thereof is improved, so as to increase the stability thereof. The metal casing of the SlimLine SAS connector engages and wraps the plastic casing for increasing the general strength. The metal casing is formed by stamping and riveting, so that the seam thereon is integrally combined. Regarding the upper and lower metal terminals, the plastic strip is embedded between the metal pin through insert injection.

### BRIEF DESCRIPTION OF THE DRAWINGS

FIG. 1 is an exploded view of the high speed connector.

FIG. 2 is a schematic view illustrating the straight foot type metal casing of the SlimLine SAS connector.

FIG. 3 is a schematic view illustrating the patch type metal casing of the SlimLine SAS connector.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

### Embodiment 1

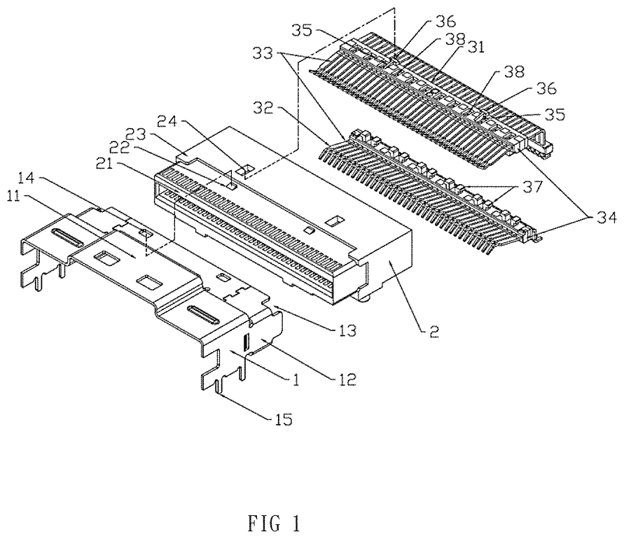

Referring to FIG. 1, a high speed connector is provided, comprising a metal casing 1, a plastic casing 2, and a terminal assembly 3.

The metal casing 1 comprises a main wall 11, a side wall 12, and a combination position 13.

The plastic casing 2 is formed in a cuboid shape and comprising a front connection portion 21 and a cover body 251, wherein the front connection portion 21 and the cover body 251 are connected to each other. The front connection portion 21 comprises an engagement member 22. The cover body 25 comprises a protrusion 23 and a terminal engagement slot 24.

The main wall 11 comprises an engagement bore 14 disposed on the main wall 11.

The side wall 12 is disposed on two sides of the main wall 11.

The combination portion 13 is formed on a junction between the main wall 11 and the side wall 12.

The front connection portion 21 and the terminal engagement slot 24 are disposed in the cover body 25 and on a lateral side of the cover body 25, respectively.

The engagement member 22 is disposed on a lateral side of the front connection portion 21.

The protrusion 23 is disposed on an insertion end of a junction of the cover body 25.

When the metal casing 1 is engaged with an outer side of the plastic casing 2, the engagement member 22 is engaged in the engagement bore 14, and the protrusion 23 is engaged in the combination position 13.

The terminal assembly 3 is inserted in the front connection portion 21 and comprises an upper terminal 31 and a lower terminal 32.

The upper terminal 31 and the lower terminal 32 comprise a metal pin 33 and a plastic strip 34.

### Embodiment 2

Referring to FIG. 1, on the basis of embodiment 1, the upper terminal 31 related to the high speed connector comprises a bolt strip 35. The bolt strip 35 is disposed on a lateral side of the upper terminal 31 and comprises a bolt body 36. The bolt body 36 is disposed on the other end portion of the bolt strip 35 connecting the upper terminal 31. When the upper terminal 31 is inserted in the front connection portion 21, the bolt body 36 is pressed by the terminal engagement slot 24 to deform, so as to be placed into the terminal engagement slot 24, and subsequently restored to the original bolt body shape and fitted in the terminal engagement slot 24. Therefore, the bolt strip 35 is fastened in the terminal engagement slot 24.

### Embodiment 3

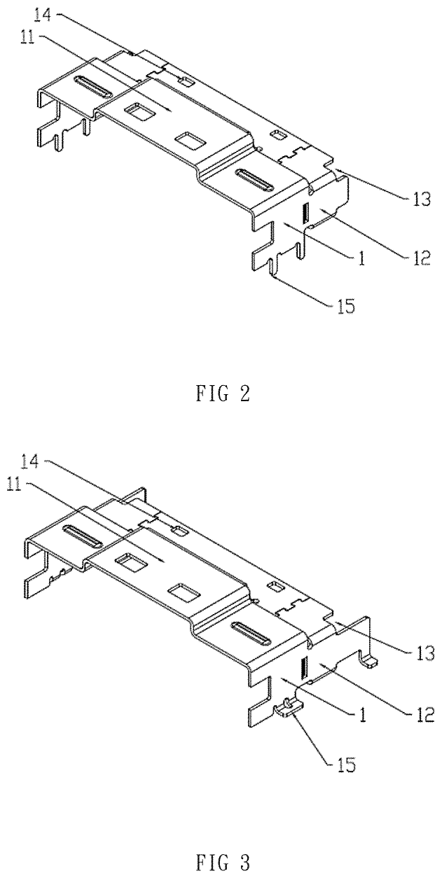

Referring to FIG. 2 and FIG. 3, on the basis of such embodiments, the side wall 12 related to the high speed connector comprises a foot 15. The foot 15 is disposed on one side of the side wall 12 which is connected with a PCB, and the foot is formed in a straight foot type or a patch type.

The straight foot type foot 15 is presented in a straight plate shape.

The patch type foot 15 is presented in a curve body.

### Embodiment 4

Referring to FIG. 1, on the basis of such embodiments, the terminal assembly 3 related to the high speed connector comprises an engagement stud 37 and an engagement slot 38. The engagement stud 37 is disposed on the lower terminal 32. The engagement slot 38 is disposed on the upper terminal 31. The upper terminal 31 and the lower terminal 32 are engaged through the engagement stud 37 and the engagement slot 38.

Although particular embodiments of the invention have been described in detail for purposes of illustration, various modifications and enhancements may be made without departing from the spirit and scope of the invention. Accordingly, the invention is not to be limited except as by the appended claims.

1. A high speed connector, comprising a metal casing, a plastic casing, and a terminal assembly;
the metal casing comprising a main wall, a side wall, and a combination position;
the plastic casing formed in a cuboid shape and comprising a front connection portion and a cover body, wherein the front connection portion and the cover body are connected to each other; the front connection portion comprising an engagement member; the cover body comprising a protrusion and a terminal engagement slot;
the main wall comprising an engagement bore disposed on the main wall;
the side wall disposed on two sides of the main wall;
the combination portion formed on a junction between the main wall and the side wall;
the front connection portion and the terminal engagement slot being disposed in the cover body and on a lateral side of the cover body, respectively;
the engagement member disposed on a lateral side of the front connection portion;
the protrusion disposed on an insertion end of a junction of the cover body;
when the metal casing being engaged with an outer side of the plastic casing, the engagement member being engaged in the engagement bore, and the protrusion being engaged in the combination position;
the terminal assembly being inserted in the front connection portion and comprising an upper terminal and a lower terminal; and
the upper terminal and the lower terminal comprising a metal pin and a plastic strip.

2. The high speed connector of claim 1, wherein the upper terminal comprises a bolt strip; the bolt strip being disposed on a lateral side of the upper terminal and comprising a bolt body; the bolt body disposed on the other end portion of the bolt strip connecting the upper terminal; when the upper terminal is inserted in the front connection portion, the bolt body is pressed by the terminal engagement slot to deform, so as to be placed into the terminal engagement slot, and subsequently restored to an original bolt body shape and fitted in the terminal engagement slot, whereby the bolt strip is fastened in the terminal engagement slot.

3. The high speed connector of claim 1, wherein the side wall comprises a foot; the foot being disposed on one side of the side wall which is connected with a PCB; the foot being formed in a straight foot type or a patch type; the straight foot type foot presented in a straight plate shape, and the patch type foot presented in a curve body.

4. The high speed connector of claim 1, wherein the terminal assembly comprises an engagement stud and an engagement slot; the engagement stud disposed on the lower terminal; the engagement slot disposed on the upper terminal; the upper terminal and the lower terminal being engaged through the engagement stud and the engagement slot.
